(19) United States
(12) Patent Application Publication
(10) Pub. No.: US 2012/0268411 A1
(43) Pub. Date: Oct. 25, 2012

(54) MULTI-MODAL CAPACITIVE TOUCHSCREEN INTERFACE

(75) Inventors: LuoSheng Chen, Briarwood, NY (US); Timothy B. Austin, Stony Brooks, NY (US); Thomas E. Wulff, North Patchoque, NY (US)

(73) Assignee: SYMBOL TECHNOLOGIES, INC., SCHAUMBURG, IL (US)

(21) Appl. No.: 13/090,130

(22) Filed: Apr. 19, 2011

(51) Int. Cl. G06F 3/045

(52) U.S. Cl. 345/174

(57) ABSTRACT

A method and apparatus for a multi-modal capacitive touchscreen interface. The multi-modal facet pertains to the mutability of the user's input modes and environments. The interface includes a display operable to display information on a device, and a touch sensitive layer disposed on the display, where the touch sensitive layer provided a plurality of capacitive nodes distributed on the display. A touch controller is coupled to the layer and is operable to detect a change of capacitance at a particular node, wherein if the touch controller detects a capacitance level at the particular node that is outside of a defined range, the touch controller automatically adjusts a sensitivity of the touch sensitive layer such that subsequent touches of the interface should fall within the defined range.

### FIELD OF THE DISCLOSURE

The present invention relates generally to a touchscreen display panel and more particularly to a capacitive touchscreen interface.

### BACKGROUND

Interactive touchscreen display panels can be implemented with various consumer, retail, business, and industrial devices, including smartphones and computing devices that are portable, mobile, or fixed. For a touch to be detected on a capacitive touchscreen panel some media has to change the capacitive fields in the touch sensor. However, existing capacitive touchscreen solutions on a smartphone and related computing devices are constrained by the input methods at touch entry.

For example, it is desired that touchscreens be operable by not only a finger (human flesh), but also a gloved hand, or a stylus (or similar object). Gloved hand compatibility with capacitive technology depends on the thickness of the glove, the type of glove material, the sensitivity of the touch panel, and the gain settings of the touch controller. Likewise, stylus compatibility with capacitive technology depends on the diameter of the stylus tip, stylus conductor material, touch panel design, and touch controller settings. All of these variables provide problems for touchscreens, resulting in poor performance when an operator wants to use a gloved hand or a stylus.

Some of these compatibility limitation problems can be overcome by adjusting the sensitivity of the capacitive touchscreen. However, this can also make it difficult to operate the touchscreen when changing the input mode. Each mode is associated with a dissimilar range of capacitance levels as sensed by the touch controller. In particular, a capacitive touchscreen system is usually tuned to a specific set of touch parameters primarily for the finger input mode, but is not necessarily tuned for both the gloved hand and the stylus of which both yield lower changes in capacitance. A set of touch parameters optimized for the finger mode input would usually not be sensitive enough for the gloved hand and stylus input modes. On the other hand, touch systems optimized for either the gloved hand or stylus would be too sensitive for finger input causing input errors. Also, higher sensitivity may allow the controller to potentially pick up environmental noise.

Furthermore, the presence of moisture and water from indoor (e.g., beverage, cleaning wipe down, etc.) and outdoor (e.g., rain, snowing, etc.) environments may contaminate a touchscreen by creating unwanted false touches.

What is needed is a robust, low-cost technique for multi-modal touchscreen input in various operating environments that provides a wide range of operating capacitance levels. It is also desirable that a device with a touchscreen be able to accommodate and adjust for different input modes during the course of user interaction.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of an informational device touchscreen interface, in accordance with the present invention.

FIG. 2 is a simplified block diagram of a touch sensitivity layer, in accordance with the present invention.

FIG. 3 is a simplified block diagram of a touch settings menu, in accordance with the present invention.

FIG. 4 is a simplified block diagram of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a novel robust and low-cost technique for multi-modal touchscreen input in various operating environments that accommodates a wide range of capacitance levels. The present invention also provides a device with a touchscreen that is able to accommodate and adjust for different input modes before and during the course of user interaction.

At present, touchscreen panels are being implemented in an increasing number of information devices, such as hand-held electronic devices for example. These devices can have display screens that incorporate touch-sensitive layers. Typically, such layers consist of electrically-conductive indium tin oxide that is deposited on a clear substrate and that is patterned to provide the touch-sensitive function. A protective layer can be disposed onto the panel to protect the conductive layer. In particular, patterned indium tin oxide layers provide distributed nodes across the panel that emits an electrostatic field. Touching the surface of the panel with a finger or other instrument results in a distortion of the touchscreen's electrostatic field at that node that is measurable as a change in capacitance, which is indicative of the user actuating a function on the device.

Devices that use touch sensitive displays are known to refer to a wide variety of consumer electronic platforms such as cellular radiotelephones, user equipment, business or industrial equipment, subscriber stations, access terminals, remote terminals, terminal equipment, cordless handsets, gaming devices, personal computers, and personal digital assistants, and the like, all referred to herein as devices. Each device comprises at least one processor that can be further coupled to a keypad, a speaker, a microphone, a display, and other features, as are known in the art and therefore not shown. The device can also include a capacitive touch controller to operate the custom touch sensors, in accordance with the present invention. It should be recognized that the controller can be a stand-alone module or can be incorporated into a host processor. The device can also include a display driver to operate the display to show information. It should be recognized that the display driver can be a stand-alone module or can be incorporated into the processor. Further, the device can also include memory. It should be recognized that the memory can be a stand-alone module or can be incorporated into any one of the processor, controller, or driver.

The figures show various assemblies adapted to support the inventive concepts of the embodiments of the present invention. Those skilled in the art will recognize that these figures do not depict all of the equipment necessary for the device and display to operate but only those components particularly relevant to the description of embodiments herein. For example, the device can include separate processors, controllers, communication interfaces, transceivers, memories, etc. In general, components such as processors, controllers, drivers, memories, and interfaces are well-known. For example, processing and controller units are known to comprise basic components such as, but not limited to, microprocessors, digital signal processors (DSPs), microcontrollers, computers, drivers, memory devices, application-specific integrated circuits (ASICs), and/or logic circuitry. Such devices are typically adapted to implement algorithms and/or protocols that have been expressed using high-level design languages or descriptions, expressed using computer instructions, expressed using messaging/signaling flow diagrams, and/or expressed using logic flow diagrams. Thus, given an algorithm or logic flow, those skilled in the art are aware of the many design and development techniques available to implement user equipment that performs the given logic. Therefore, the processors, controller, and drivers represents a known apparatus that has been adapted, in accordance with the description herein, to implement various embodiments of the present invention.

Those skilled in the art are aware of the many design and development techniques available to configure a processor and a controller that implement the touch-sensitive control of a display. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. It is within the contemplation of the invention that the operating requirements of the present invention can be implemented in software, firmware or hardware, with the function being implemented in a controller (or a digital signal processor) being merely an option.

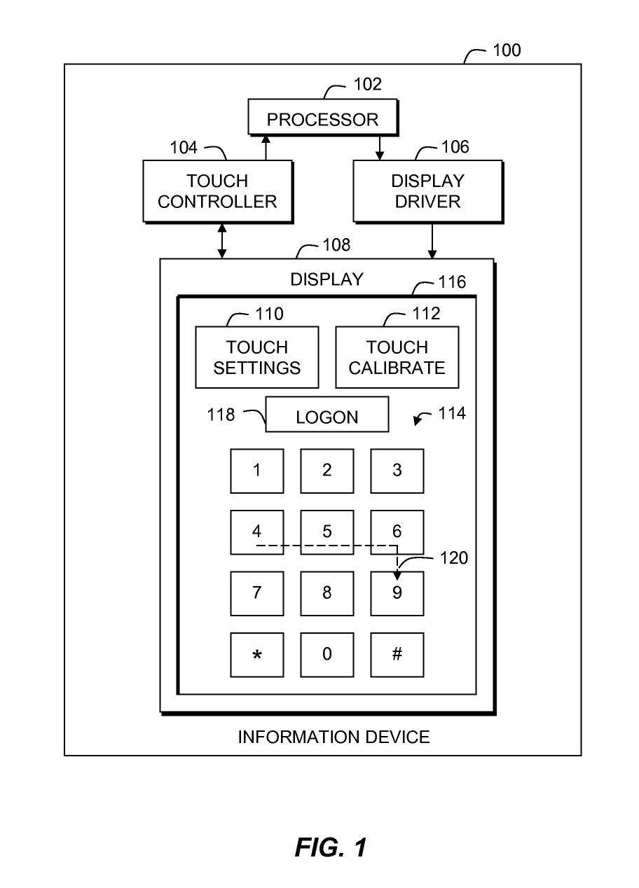

Referring to FIG. 1, an information device 100 is shown with a touchscreen interface, in accordance with the present invention. The device 100 can include a host processor 102, a display driver 106, a touch controller 104, and a display 108 incorporating a touch sensitive layer 116 to provide a touchscreen panel. The processor, controller, and driver can be incorporated into one module or a plurality of modules. The display 108 is operable to display information to a user of the information device. The display can be a liquid crystal display, electroluminescent diode display, organic light emitting diode display, bistable display, and the like, which can be controlled by the processor 102 and/or driver 106, as is known in the art. The touch sensitive layer 116 can be part of either a touchscreen panel that is inherently a separate entity from the display (e.g., liquid crystal display) or disposed on the display inside the electronic touch layer of the display 108. The touch sensitive layer provides a plurality of capacitive nodes distributed across the display. The processor directs the display driver to display functional information, such as icons, textual, or graphical images to the user that are located in proximity to capacitive nodes of the touch sensitive layer. The touch controller is coupled to the touch sensitive layer and can detect a user placing her finger or other implement above the node by noting a change of capacitance at that node. The touch controller knows the x,y coordinates of each node due to its placement on the display, and will provide the coordinates of any actuated node to the processor, directing the processor to implement the function displayed at the location of that actuated node.

In accordance with the present invention, if the touch controller detects a capacitance change or level at the actuated node that is outside of a defined range, the touch controller adjusts a sensitivity of the touch sensitive layer such that subsequent touches of the touch sensitive layer of the touchscreen interface should fall within the defined range. In effect, the present invention is a touchscreen interface that allows for automatic self-calibration (or re-baselining) for various input modes in shell and application environments. The input modes considered herein include an operator or user actuating functions of the information device using any one or more of a: dry finger, dry gloved hand, dry stylus/object, wet finger, wet gloved hand, and wet stylus/object, each of which is associated with a certain capacitance level or range. At present, touchscreens have not been developed to have an all-encompassing sensitivity range for all of these modes to be used simultaneously. It should be noted that the present invention is not limited to these six input modes, but also is applicable to any environment that would alter the capacitance sensitivity of a touchscreen. For example, locating the device in proximity to other electrical devices or in a noisy electromagnetic environment could influence the field sensitivity of the information device.

In a preferred embodiment, the capacitive sensitivity of the touchscreen interface is established before operating designed functionalities of the device, such as when the information device is first turned on, or during a logon procedure. For example, touchscreen capacitive sensitivity is established before communicating on a communications device. Upon turn-on or during logon, the operator of a device encounters graphical information or icons on a display screen that is typically expected of common smartphones and mobile devices. For example, referring back to FIG. 1, a keypad 114 or other logon device can be displayed to a user. Typical logon touchscreens involve pressing a button to unlock the device, sliding of a tab or icon, entry of a security password or number, or some unique gesture that reflects the logon protocol expected by that device. In one example logon protocol, a user may be asked to enter a four digit code (e.g. 4569) on the keypad 114 followed by an OK or logon entry 118. In another example logon protocol, an OK or logon entry is not needed if a user can swipe 120 her finger over the four digit code, or over four particular icons or locations. In another example logon protocol, for a logon interface that allows multi-touch, the operator can apply a simple gesture such as tracing one or more independent lines from a previously programmed touch region to tapping one or more identified and sensitive corners or prescribed regions of the touchscreen with independent fingers.

In any of the above logon procedures, the user will provide initial input information to the device by touching the touchscreen, and therein provide sensitivity information for the device to use for automatic self-calibration. For example, if a user is using a gloved hand during logon, the device may detect a weaker than expected capacitance change on the touchscreen and subsequently increase the touchscreen sensitivity by increasing the electrostatic field of the nodes of the touch sensitivity layer 116. Since, the device will be unaware, at turn on, what input mode the user may use, the touch controller could adjust the touchscreen interface for default or maximum sensitivity at turn on. In this way, all input modes could be detected, including a typically weak input mode such as a dry stylus, whereas an ungloved finger would only produce too much capacitance change, causing the touch controller to reduce sensitivity. These sample gesture events will trigger the touch system to complete a detection of the input modes' capacitance levels and to perform an automatic self-calibration to normalize the capacitance levels to within a predefined operating range.

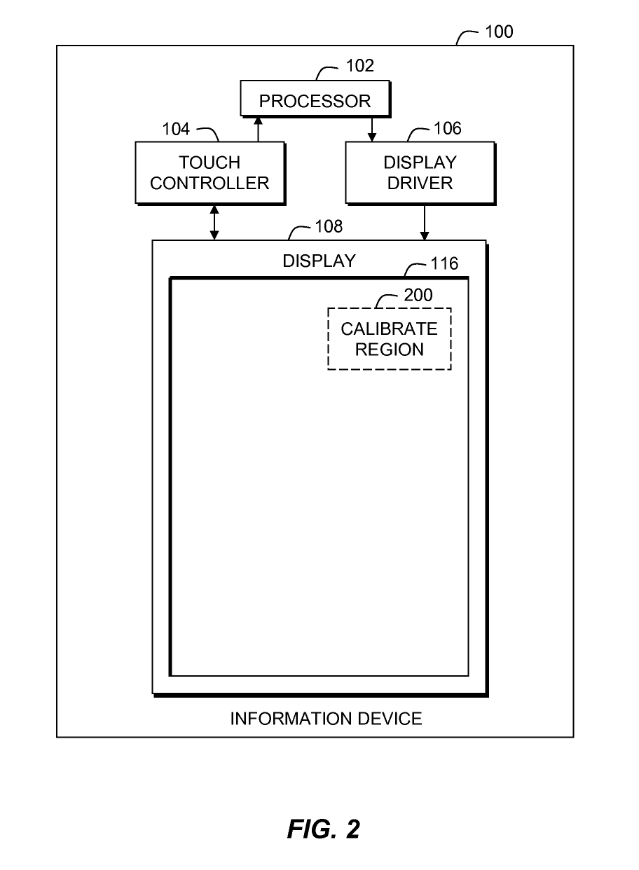

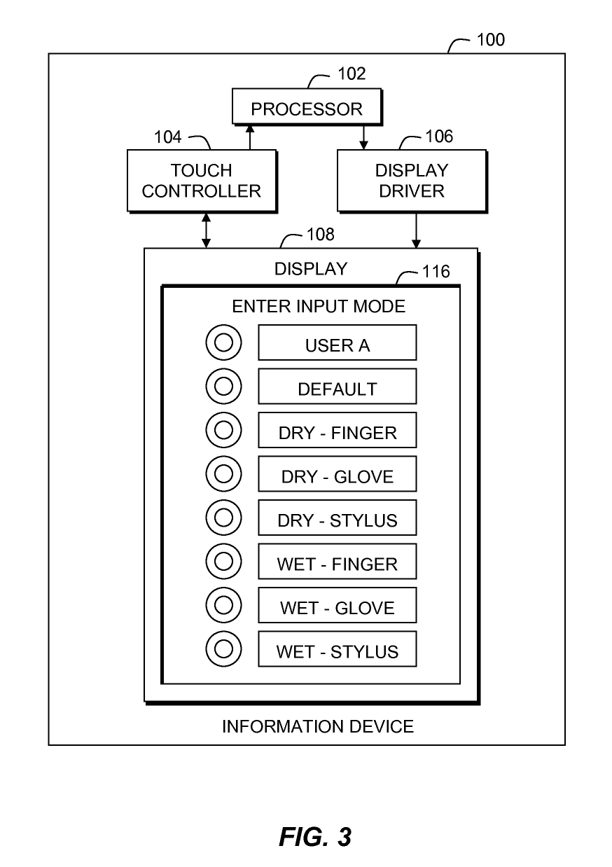

In an alternative embodiment, touchscreen calibration can be performed outside of logon protocols. For example, a touch calibrate function 112 can be provided to a user at turn on, where a user can simply touch or hold this icon for the touch controller to calibrate (or soft reboot) the touchscreen sensitivity. Since there is only one opportunity for calibration in this example the touch controller could adjust one or more regions (200 in FIG. 2) of touchscreen nodes for maximum sensitivity at turn on, or at least a higher capacitive sensitivity than other regions of the touchscreen. In this way, all input modes of the touch calibrate function could be detected, causing the touch controller to reduce sensitivity if there is too much capacitance change or too high a capacitance level. In another example, a touch settings function 110 can be provided for operator adjusted settings, where a user selecting this function can be provided a pull-down menu of various input modes to select as shown in FIG. 3, such as a personal default setting of a user (A), a default setting, or one of many preset setting, such as wet environment using a stylus. The touch controller can calibrate the touchscreen sensitivity for the selected input mode setting using pre-stored capacitive sensitivity settings. Both of these alternative embodiments can be performed before logon allowing the operator to lockdown on a touch setting prior to logging onto the shell environment. Of course it should be recognized also that both of these alternative embodiments could be implemented after successful logon and once inside the multi-modal shell and application environments.

In an optional embodiment, the touch controller can continuously or periodically monitor the user operation of the touchscreen over time, and continuously or periodically calibrate and adjust the touch sensitivity with time.

In the above embodiments, only single point entry has been described. However, the present invention also accommodates provides multiple point entry on the touchscreen. Under this multi-modal touchscreen interface, the operator can employ a combination of touch input modes. For example, a multi-modal touchscreen logon interface can also accommodate two input modes simultaneously, such as a finger and a gloved hand, or can either three dry modes (i.e., dry gloved hand, dry finger, dry stylus/object) simultaneously or three wet modes (i.e., wet finger, wet gloved hand, and wet stylus/object) simultaneously. Since touching the surface of a capacitive touchscreen results in a distortion of the touchscreen's electrostatic field that is measurable as a change in capacitance, the multi-modal logon interface characterizes the capacitance level of each input mode to perform an automatic calibration accordingly. As a result, different regions of the touchscreen can be prescribed to and adjusted for different input modes having different capacitive sensitivities.

In any of the above embodiments, it is envisioned that the processor can be configured to interpret and calibrate various single-touch gestures and events (e.g., tap), as well as combined multi-modal and multi-touch gestures and events.

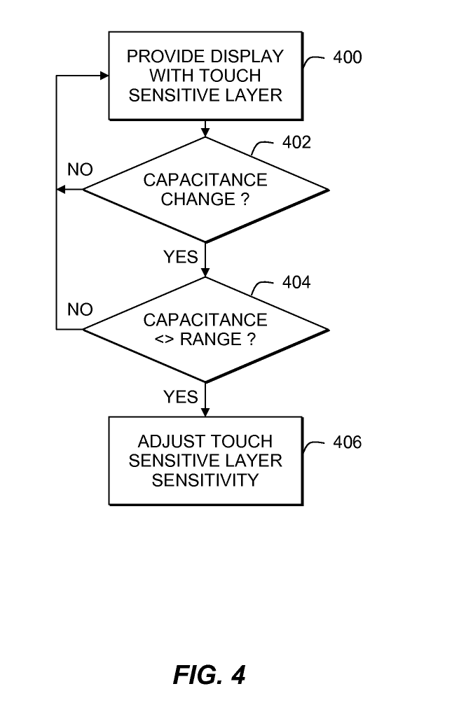

FIG. 4 illustrates a flowchart of a method for interfacing with a multi-modal capacitive touchscreen, the method includes a first step of providing 400 a display for displaying information on a device and a touch sensitive layer including a plurality of capacitive nodes distributed on the display. This step can include establishing a capacitive sensitivity of the touchscreen before operating designed functionalities of the device, such as upon turning on the device or during a logon procedure of the device, and can include establishing a maximum capacitive sensitivity upon turning on the device. This step can also include establishing a capacitive sensitivity of the device by user selection of pre-stored settings. This step can also include establishing a capacitive sensitivity by providing a touch calibrate function on the device to be manually operated by a user of the device. For example, the touch calibrate function can be provided at a particular region of the touchscreen having a higher capacitive sensitivity than other regions of the touchscreen.

A next step includes detecting 402 a change of capacitance at a particular node.

A next step includes determining 404 if a capacitance level at the particular node is outside of a defined range.

A next step includes automatically adjusting 406 a sensitivity of the touch sensitive layer such that subsequent touches of the interface should fall within the defined range. Adjusting can be done at turn on of the device, during the logon procedure, and periodically or continuously, during operation of the device by a user over time. This step can also accommodate different capacitive sensitivities of respective different user input modes simultaneously. In particular, adjusting can be done for different regions of the touchscreen for different input modes having different respective capacitive sensitivities.

Advantageously, the present invention provides a new standard interface designed to operate on a capacitive touchscreen panel in both dry and wet operating environments and with various input modes. The present invention references a logon interface screen that senses surface wetness through differentiating a wet touch from a dry touch. The present invention takes advantage of the logon interface to conduct an initial screening of the touch input modes. The multi-modal touchscreen interface allows the operator to have seamless user interaction between modes through automatic system self-calibration as well as user-controlled settings for optimum touch sensitivity. The interface allows for standard multi-modal touch interaction with a device's default user settings as well as increased user control to enhance and personalize interaction experience on a device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs for ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A multi-modal capacitive touchscreen interface, comprising:
a display operable to display information on a device;
a touch sensitive layer disposed on the display, the touch sensitive layer providing a plurality of capacitive nodes distributed on the display; and
a touch controller coupled to the layer, the touch controller operable to detect a change of capacitance at a particular node, wherein if the touch controller detects a capacitance level at the particular node that is outside of a defined range, the touch controller can automatically adjust the sensitivity of the touch sensitive layer such that subsequent touches of the interface should fall within the defined range.

2. The interface of claim 1, wherein the touch controller establishes a capacitive sensitivity of the touchscreen before operating designed functionalities of the device.

3. The interface of claim 2, wherein the touch controller establishes a capacitive sensitivity upon turning on the device.

4. The interface of claim 2, wherein the touch controller establishes a capacitive sensitivity during a logon procedure of the device.

5. The interface of claim 2, wherein the touch controller establishes a maximum capacitive sensitivity upon turning on the device.

6. The interface of claim 1, wherein the touch controller establishes a capacitive sensitivity of the device by user selection of pre-stored settings.

7. The interface of claim 1, wherein the touch controller adjusts a capacitive sensitivity during operation of the device by a user.

8. The interface of claim 1, wherein the touch controller establishes a capacitive sensitivity by providing a touch calibrate function on the device to be manually operated by a user of the device.

9. The interface of claim 8, wherein the touch calibrate function is provided at a particular region of the touchscreen having a higher capacitive sensitivity than other regions of the touchscreen.

10. The interface of claim 1, wherein the touch controller accommodates different capacitive sensitivities of different user input modes simultaneously.

11. The interface of claim 10, wherein the touch controller adjusts different regions of the touchscreen for different input modes having different capacitive sensitivities.

12. An information device with a multi-modal capacitive touchscreen interface, comprising:
a display operable to display information on the device;
a touch sensitive layer disposed on the display, the touch sensitive layer providing a plurality of capacitive nodes distributed on the display; and
a touch controller coupled to the layer, the touch controller operable to detect a change of capacitance at a particular node, wherein if the touch controller detects a capacitance level at the particular node that is outside of a defined range, the touch controller can automatically adjust the sensitivity of the touch sensitive layer such that subsequent touches of the interface should fall within the defined range.

13. A method for interfacing with a multi-modal capacitive touchscreen, the method comprising the steps of:
providing a display for displaying information on a device and a touch sensitive layer including a plurality of capacitive nodes distributed on the display;
detecting a change of capacitance at a particular node;
determining if a capacitance level at the particular node is outside of a defined range; and
automatically adjusting a sensitivity of the touch sensitive layer such that subsequent touches of the interface should fall within the defined range.
